(19) United States
(12) Patent Application Publication
(10) Pub. No.: US 2010/0024759 A1
(43) Pub. Date: Feb. 4, 2010

(54) TWO-STROKE ENGINE

(76) Inventor: Gary E. Dobransky, Johnson City, NY (US)

Correspondence Address: BROWN & MICHAELS, PC;400 M & T BANK BUILDING, 118 NORTH TIOGA ST, ITHACA, NY, 14850, US

(21) Appl. No.: 12/512,636

(22) Filed: Jul. 30, 2009

Related U.S. Application Data
(60) Provisional application No. 61/137,535, filed on Jul. 31, 2008.

(51) Int. Cl. F02F 3/00; F01B 31/10

(52) U.S. Cl. 123/193.6; 92/160

(57) ABSTRACT

The two-stroke engine includes an engine head, a cylinder block, and a lower block. The lower block is sealed from the engine head except for a cylinder bore in the cylinder block. A piston in the cylinder block has at least one compression ring groove for a compression ring to seal the lower block from the engine head. The piston also includes an oil control ring groove for an oil control ring to provide appropriate lubrication to the compression ring during each stroke of the piston. The piston further includes at least one drainage opening providing fluid communication between the outer circumference of the piston and an interior surface of the piston.

### REFERENCE TO RELATED APPLICATIONS

This application claims one or more inventions which were disclosed in Provisional Application No. 61/137,535, filed Jul. 31, 2008, entitled “INTERNAL COMBUSTION ENGINE”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of engines. More particularly, the invention pertains to a two-stroke engine and a piston for a two-stroke engine.

2. Description of Related Art

Two-stroke engines are known in the art. A two-stroke engine completes a cycle in two strokes of the piston or pistons: an upward stroke and a downward stroke. Basically, intake and compression occur on one stroke, and combustion and exhaust occur in a second stroke.

Two-stroke engines are commonly used in high-power, hand-held equipment such as trimmers and chainsaws. Two-stroke engines may also be used in other industries, such as motorcycling, boating, and snowmobiling. Two-stroke engines are commonly used in equipment such as lawnmowers, snowmobiles, scooters, mopeds, some motorcycles, ultralights, model airplanes, personal watercraft, and outboard motor boats. Conventional two-stroke engines have different fuel and oil requirements from four-stroke engines.

Conventional two-stroke engines are simpler and lighter than four-stroke engines but have a number of disadvantages that limit their usefulness. Up until about the mid-1980's, two-stroke engines ran on a pre-mixed mixture of oil and fuel. The fuel in the mixture combusted to run the engine, while the oil was used to lubricate the moving parts of the engine, including the piston and connecting rod and crankshaft bearings. The ratio of oil to fuel needed to be just right, because too little oil would cause the engine to seize, and too much oil would cause the engine to smoke. Some of the oil made its way into the combustion chamber, where it would burn and leave the exhaust as smoke polluting the atmosphere or a deposit on the surfaces of the combustion chamber. Additionally, mixing fuel in the oil reduces the ability of the oil to lubricate the moving parts. For these reasons, conventional two-stroke engines ran dirtier and were less durable than four-stroke engines. For example, a two-stroke engine for a snowmobile typically required a top end rebuild after about 6,000 to 8,000 miles of usage.

Subsequent improvements to two-stroke engines included the addition of an oil pump to supply the oil so that it no longer needed to be pre-mixed with the fuel, semi-direct injection of the fuel at a transfer port, and direct injection of the fuel into the combustion chamber. In all of these engines, however, lubricating oil was still able to reach the combustion chamber, where it would burn, eventually fouling the engine parts and being expelled to pollute the environment.

U.S. Pat. No. 4,672,931 discloses a lubrication system for a two-stroke engine with inlet and outlet oil ports in the cylinder for providing lubricating oil to lubricate the piston during operation of the two-stroke engine. The lubricating oil is provided to a scraper ring having an I-shaped cross section and seated in a groove in the lower portion of the piston. A hole in the scraper ring allows fluid communication between the portion of oil between the ring and the cylinder and the portion of oil between the ring and the piston. The lubrication system supplies oil only to an outer portion of the piston and a portion of the cylinder.

### SUMMARY OF THE INVENTION

The two-stroke engine includes an engine head, a cylinder block, and a lower block. The lower block is sealed from the engine head except for a cylinder bore in the cylinder block. A piston in the cylinder block has at least one compression ring groove for a compression ring to seal the lower block from the engine head. The piston also includes an oil control ring groove for an oil control ring to provide appropriate lubrication to the compression ring during each stroke of the piston. The piston further includes at least one drainage opening providing fluid communication between the outer circumference of the piston and an interior surface of the piston.

In one embodiment of the present invention, the two-stroke engine includes an engine head, a lower block housing a crankshaft, a cylinder block between the engine head and the lower block and housing a piston, a connecting rod connecting the piston to the crankshaft, and an oil control ring. The cylinder block has a cylinder bore, an intake port into the cylinder bore, and an exhaust port exiting the cylinder bore. The lower block is sealed from the engine head such that the cylinder bore provides the only fluid communication between the lower block and the engine head. The piston has at least one drainage opening providing fluid communication between an outer circumference of the piston and an interior surface of the piston. The first compression ring is located in a first compression groove of an upper portion of the piston. The first compression ring forms the first sliding seal between the piston and the cylinder bore, and no further seal is formed between the piston and the cylinder bore above the first compression groove. The oil control ring is located in a control groove of a lower portion of the piston at a predetermined distance below the first compression ring such that the oil control ring does not rise above the bottom of any exhaust or intake ports during the upstroke of the piston. The oil ring forms a second sliding seal between the piston and the cylinder bore. The oil control ring spreads sprayed or splashed oil to from an oil film between the piston and cylinder bore.

The present invention includes the method of lubricating a two-stroke engine including an engine head, a lower block housing a crankshaft, and a cylinder block housing a piston in a cylinder bore of the cylinder block. The method includes the step of sealing the lower block from the engine head such that the cylinder bore provides the only fluid communication between the lower block and the engine head. The method also includes the step of supplying lubricating oil to the bottom surfaces of the piston and the cylinder bore below the piston. The method further includes the step of forming a first sliding seal between the piston and the cylinder bore with a first compression ring in a first compression groove of an upper portion of the piston, and no further seal is formed between the piston and the cylinder bore above the first compression groove. The method also includes the step of forming a second sliding seal between the piston and the cylinder bore with an oil control ring in a control groove of a lower portion of the piston at a predetermined distance below the first compression ring such that the oil control ring does not rise above a bottom of the exhaust or the intake port during an upstroke of the piston. The oil control ring spreads sprayed or splashed oil to from an oil film between the piston and cylinder bore and a second sliding seal between the piston and the cylinder bore. The method further includes the step of draining excess lubricating oil between the first compression ring and the oil control ring to the lower block through at least one drainage opening in the piston.

The present invention includes a novel piston for a two-stroke engine that has a cylindrical shape including an upper surface and an outer circumference. The piston also has a first compression ring groove around the outer circumference of an upper portion of the piston, and no further compression ring groove is formed above the first compression ring groove. The piston further has an oil control ring groove around the outer circumference of a lower portion of the piston at a predetermined distance below the first compression ring groove such that the oil control ring does not rise above the bottom of any exhaust or intake ports during the upstroke of the piston. The piston also has at least one drainage opening providing fluid communication between the outer circumference of the piston and an interior surface of the piston.

### BRIEF DESCRIPTION OF THE DRAWINGS

FIG. 1 schematically shows a two-stroke engine at the top position in an embodiment of the present invention.

FIG. 2 schematically shows a two-stroke engine at the bottom position in an embodiment of the present invention.

FIG. 3 schematically shows a cross sectional view of a piston for a two-stroke engine in an embodiment of the present invention.

### DETAILED DESCRIPTION OF THE INVENTION

The top position of a piston as used herein is commonly referred to as the top dead center position in the art of engines.

The bottom position of a piston as used herein is commonly referred to as the bottom dead center position in the art of engines.

In some embodiments, the two-stroke engine runs or operates without any pre-mixed or injected lubricating oil.

In some embodiments, the two-stroke engine runs with rates of consumption and burning of lubricating oil comparable to rates occurring in four-stroke engines.

In some embodiments, substantially all of the lubricating oil is self-contained and sealed from the combustion process.

The lower block or crank case area of a two-stroke engine of the present invention is preferably completely sealed from the cylinder block except for the cylinder bore, the piston bottom, and an air expansion chamber being part of the lower block and possibly the cylinder block.

A piston for a two-stroke engine of the present invention includes at least one compression ring, preferably a scraper ring, and an oil control ring.

In some embodiments, the two-stroke engine includes a wet sump, where the lower block or crankcase area contains lubricating oil such that the main crank is bathed or immersed in the oil and during its rotation creates a splash to lubricate both the cylinder bore and the piston.

In other embodiments, the two-stroke engine includes a dry sump, where oil drains to an oil reservoir and is pumped under pressure back to the lower block or crankcase area to lubricate the main crank, the cylinder block, and the lower piston area.

In both wet and dry sump embodiments, the lubricating oil is preferably pumped, filtered, cooled, and returned to the lower block during operation of the two-stroke engine.

In some embodiments, induction air is pressurized and supplied to the cylinder area by a blower, a turbocharger, a supercharger, a compressor, or other mechanical device.

In some embodiments, the fuel for combustion is supplied to the two-stroke engine by carburetion, throttle body injection, semi-direct injection, or direct injection.

The intake port, the exhaust port, or both the intake and exhaust ports may be either fixed or timed by the use of a valve.

A two-stroke engine of the present invention is preferably cooled by either air or a cooling fluid and may be started by an electromechanical starter or a pull rope.

Exhaust gases from a two-stroke engine of the present invention may be plumbed to the atmosphere through a chamber, a pipe, a muffler, or a catalytic converter.

In some embodiments, the lower block or crankcase area is vented to stabilize or relieve any internal air pressure and routed to an air intake system for combustion and pollution control.

In some embodiment, the intake air or induction air is filtered prior to introduction to the combustion area to prevent unwanted or undesired particulates from contaminating the combustion area.

In some embodiments, the lower block includes an oil drain plug, which is preferably magnetic, to facilitate oil drainage and metallic particulate absorption.

In some embodiments, maintenance issues, including, but not limited to, continual oil purchases, continual spark plug replacements, summerizations, winterizations, and top end rebuilds associated with conventional two-stroke engines are virtually eliminated.

A two-stroke engine of the present invention preferably has a reliability, a dependability, and a longevity far greater than conventional two-stroke engines and equal to or better than conventional four-stroke engines.

In some embodiments, all smoke is eliminated during operation of the two-stroke engine.

In some embodiments, the lubricating oil is periodically drained from the two-stroke engine, changed, and recycled.

A two-stroke engine of the present invention preferably uses the same combustion fuel and lubricating oil as conventional four-stroke engines.

In some embodiments, the two-stroke engine has no transfer ports.

In one embodiment of the present invention, the two-stroke engine weights about 70 pounds and operates at a speed up to about 8,000 rpm, and the piston travels about 2¾″ from bottom to top position.

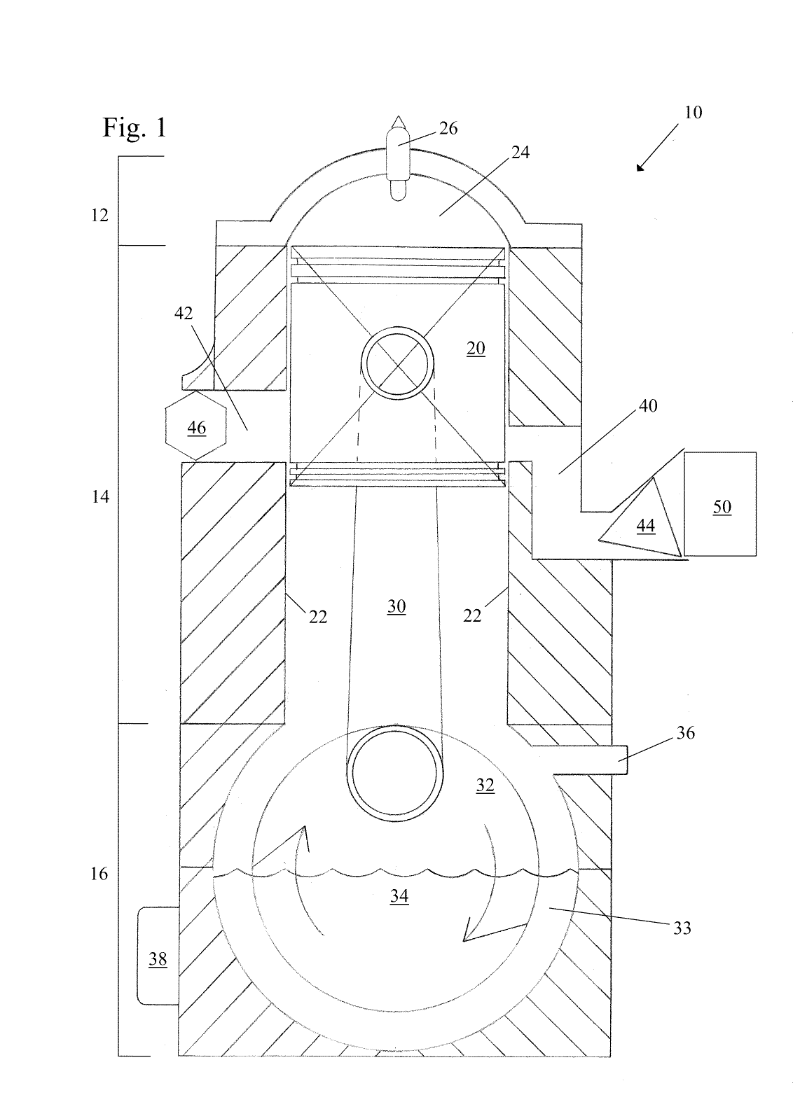

FIG. 1 shows a two-stroke engine with the piston at the top position in an embodiment of the present invention. The engine 10 includes a head 12, a cylinder block 14, and a two-piece/split lower block 16. The piston 20 is at its uppermost position in the cylinder bore 22 at the top of the compression stroke, where the fuel is compressed in the combustion chamber 24 and the spark plug 26 ignites the compressed fuel. Although only one spark plug is shown in FIG. 1, two or more spark plugs may be used with each piston within the spirit of the present invention. A connecting rod 30 connects to the piston 20 by a wrist pin and to the crankshaft 32 by a crank pin. In this embodiment with a wet sump 33, the crankshaft 32 is submerged in the lubricating oil 34 and splashes lubricating oil onto the cylinder bore 22 and bottom surfaces of the piston 20 during its rotation. A crankcase vent 36 permits equalization of pressure between upstrokes and downstrokes in the otherwise sealed lower chamber. In some embodiments, the cooling system 38 includes circulation of cooling water using a water pump. The water pump circulates fluid throughout the whole entire engine during operation of the two-stroke engine. In some embodiments, fan/air cooling is used.

In the top position, both the intake port 40 and the exhaust port 42 are blocked by the piston. In FIG. 1, an intake valve 44 permits air flow into the engine through the intake port but blocks air flow out of the engine through the intake port, although the two-stroke engine may operate without an intake valve within the spirit of the present invention. In some embodiments, the intake valve is a reed valve. An exhaust valve 46 permits air flow out of the engine through the exhaust port but blocks air flow into the engine through the exhaust port, although the two-stroke engine may operate without an exhaust valve within the spirit of the present invention. The fuel and air are supplied to the engine through the intake port by an intake source 50. The intake source may be a carburetor or a throttle body and throttle body fuel injector.

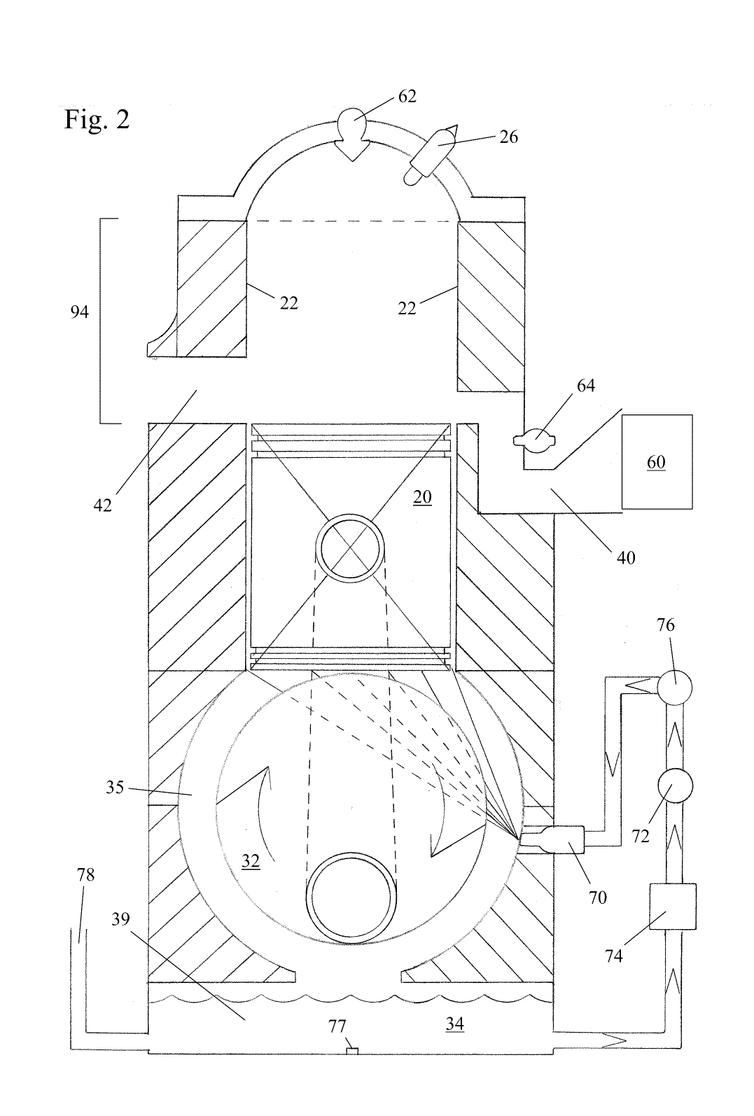

FIG. 2 shows a two-stroke engine with the piston at a bottom position in an embodiment of the present invention. The piston 20 is at its lowermost position in the cylinder bore 22 at the bottom of the exhaust stroke, where the piston is clear of both the intake port 40 and the exhaust port 42. During the exhaust stroke, the piston is driven from the top position to the bottom position by the combustion of the fuel in the combustion chamber. Exhaust gases are drawn or forced out of the exhaust port as the fresh air is pumped into the engine through the intake port 40. The air is supplied to the engine through the intake port by an intake source 60. In some embodiments, the fuel is supplied by direct fuel injection with a fuel injector 62 preferably located at the top center of the engine head as shown in FIG. 2. In these embodiments, the spark plug 26 is preferably located off-center as shown in FIG. 2. In other embodiments, the fuel is supplied by semi-direct fuel injection with a fuel injector 64 supplying fuel to the intake port near the entrance to the cylinder bore. The intake source supplies forced air to the intake port. The intake source may be a blower, a turbocharger, a supercharger, a compressor, or other mechanical device.

In the embodiment of FIG. 2, the crankshaft 32 remains above the level of the lubricating oil 34 in the dry sump 35 during the entire engine cycle. A crankcase oil injector 70 supplies oil to the bottom of the piston, to the crankshaft, and to the cylinder bore during operation of the engine. Although FIG. 2 shows only one oil injector, two or more oil injectors may be used with each dry sump within the spirit of the present invention. The oil injector is located to the side of the crankshaft and sprays the oil at an upward angle toward the bottom of the piston. The oil lubricates the piston, cylinder bore, connecting rod, and crankshaft before dripping back down into the dry sump. An oil pump 72 supplies oil from the dry sump to the oil injector. Preferably, an oil cooling system 74 cools the oil, and an oil filter 76 filters the oil as it is pumped from the dry sump to the oil injector. The dry sump 35 is supplied with oil by an external oil reservoir 39 and includes an oil drain plug 77 so that the oil can be periodically drained and replaced. An oil fill and dipstick tube 78 allows the oil level to be checked and adjusted externally.

In a preferred embodiment, the two-stroke engine includes one or more units, such as the unit shown in FIG. 1 or the unit shown in FIG. 2, arranged side-by-side, opposing, or in a V-configuration with the units driving a common crankshaft. The engine may include 1, 2, 3, 4, or more than four units. The units are preferably timed such that one is at the top position when the other is at the bottom position, and vice versa. A two-stroke engine may, however, include more than one piston driving more than one crankshaft or include only one piston within the spirit of the present invention.

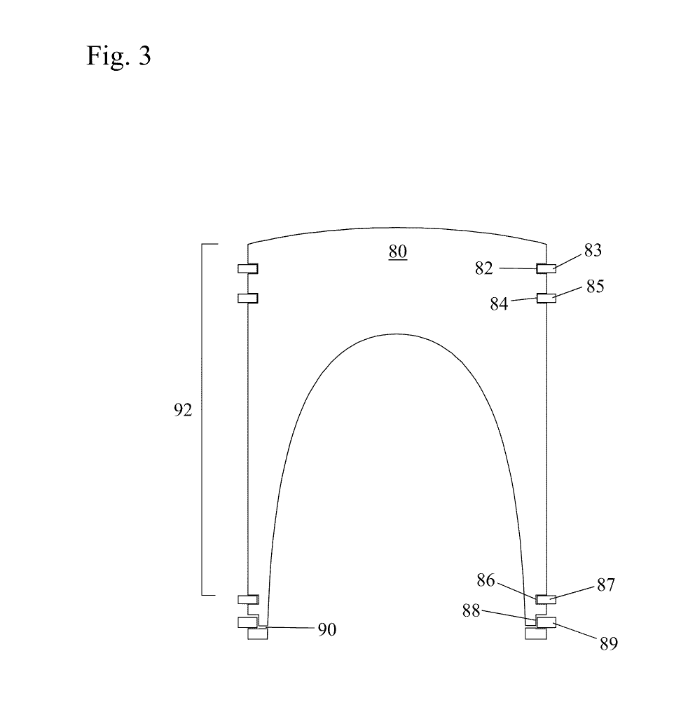

FIG. 3 shows a cross sectional view of a piston for a two-stroke engine in an embodiment of the present invention. The piston 80 in the cylinder bore seals the engine head from the lower block so that fuel is prevented from entering the lower block, but more importantly, so that lubricating oil is prevented from entering the engine head. Preferably, the only ports in fluid communication with the engine head are the intake port and the exhaust port. A piston of the present invention includes a top surface and at least two grooves around the outer circumference of the piston. The top surface may be flat as in FIGS. 1 and 2 or domed as in FIG. 3 to suit design requirements and how much compression is desired. FIG. 3 shows a piston with four grooves. The two upper grooves 82, 84 are compression ring grooves holding compression rings 83, 85. Although two compression rings are preferred, a two-stroke engine of the present invention may have only one compression ring in an upper groove. The top groove 82 is preferably located near the top of the piston. The first lower groove 86 is an optional groove that may hold nothing or either a compression ring or a scraper ring 87. The lowest groove 88 holds an oil control ring 89. The piston is preferably partially hollowed out from the bottom of the piston. The lowest groove 88 is preferably located near the bottom of the piston. The piston preferably includes at least one piston drainage opening 90 allowing excess lubricating oil to drain from the outer circumference of the piston to the inner hollowed out portion, where it then drains back down into the lower block of the engine. More preferably, a plurality of drainage openings are located around the piston circumference. In one embodiment, the piston has ten drainage openings. The drainage openings are preferable located in the oil control ring groove 88 or a part thereof.

The piston 80 is preferably sized and the grooves are preferably spaced such that the following conditions are met:
1) the intake and exhaust ports are unblocked by the piston when the piston is at the bottom position;
2) the intake and exhaust ports are blocked by the piston when the piston is at the top position;
3) the oil control ring 89 remains below the intake port and the exhaust port and maintains a complete seal with the cylinder bore during the entire stroke of the piston; and
4) the distance 92 between the compression ring and the scraper ring is about equal to the distance 94 that the piston travels between its uppermost position and its lowermost position during operation of the two-stroke engine so that the compression ring 83 receives lubricating oil left by the oil control ring on the upstroke.

It is also preferred that no further seal between the cylinder bore and piston will be formed below the oil ring so that oil can drain back into the sump.

In a preferred method of lubrication of the present invention, lubricating oil is deposited on the surfaces of the cylinder bore below the piston during each upstroke of the piston. This may be done by splashing of the lubricating oil in the case of a wet sump or by controlled spraying with an oil injector in the case of a dry sump. During the upstroke and the downstroke of the piston, the oil control ring permits a thin layer of oil to be maintained as a coating on the cylinder bore for lubrication of the compression ring during the next upstroke and downstroke of the piston. Additionally and preferably, a scraper ring may be incorporated just above the oil control ring to control the thickness of the oil coating on the cylinder bore. As with the oil control ring, the scraper ring does not rise above the intake and exhaust ports during operation of the two-stroke engine. Any excess oil accumulating between the scraper ring and the oil control ring drains through the piston drainage openings and back to the lower block and sump. The top compression ring substantially prevents any lubricating oil from reaching the engine head such that the levels of oil loss and oil burning are comparable to those for a four-stroke engine.

In a two-stroke engine of the present invention, all oil used to lubricate, operate, and run the engine can be timely and periodically drained, changed, and recycled, thus leaving no lubricating oil unnecessarily consumed and burned along with its subsequent contaminating pollution to be lost forever to the atmosphere.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A two-stroke engine comprising:
an engine head;
a lower block housing a crankshaft;
a cylinder block between the engine head and the lower block and having a cylinder bore, an intake port into the cylinder bore, and an exhaust port exiting the cylinder bore, wherein the lower block is sealed from the engine head such that the cylinder bore provides the only fluid communication between the lower block and the engine head;
a piston housed in the cylinder bore, the piston having at least one drainage opening providing fluid communication between an outer circumference of the piston and an interior surface of the piston;
a connecting rod connecting the piston to the crankshaft;
a first compression ring in a first compression groove of an upper portion of the piston, the first compression ring forming a first sliding seal between the piston and the cylinder bore, wherein no further seal is formed between the piston and the cylinder bore above the first compression groove; and
an oil control ring in a control groove of a lower portion of the piston at a predetermined distance below the first compression ring such that the oil control ring does not rise above a bottom of the exhaust or the intake port during an upstroke of the piston, the oil control ring forming a second sliding seal between the piston and the cylinder bore.

2. The engine of claim 1, wherein the predetermined distance is selected to be about equal to a distance of travel of the piston from a top position to a bottom position.

3. The engine of claim 1, wherein the at least one drainage opening is located in the oil control ring groove.

4. The engine of claim 1, wherein the at least one drainage opening is a plurality of drainage openings.

5. The engine of claim 1 further comprising a second compression ring in a second compression groove between the first compression groove and the control groove of the piston.

6. The engine of claim 1, further comprising a fuel supplier selected from the group consisting of a carburetor, a throttle body fuel injector, a semi-direct fuel injector, and a direct fuel injector.

7. The engine of claim 1, further comprising a wet sump in the lower block.

8. The engine of claim 1, further comprising a dry sump and an oil injector feeding the dry sump in the lower block.

9. A method of lubricating a two-stroke engine comprising an engine head, a lower block housing a crankshaft, and a cylinder block housing a piston in a cylinder bore of the cylinder block, the method comprising the steps of:
a) sealing the lower block from the engine head such that the cylinder bore provides the only fluid communication between the lower block and the engine head;
b) supplying lubricating oil to the bottom surfaces of the piston and the cylinder bore below the piston during an upstroke of the piston;
c) forming a first sliding seal between the piston and the cylinder bore with a first compression ring in a first compression groove of an upper portion of the piston, wherein no further seal is formed between the piston and the cylinder bore above the first compression groove;
d) forming a second sliding seal between the piston and the cylinder bore with an oil control ring in a control groove of a lower portion of the piston at a predetermined distance below the first compression ring such that the oil control ring does not rise above a bottom of the exhaust or the intake port during an upstroke of the piston; and
e) draining excess lubricating oil between the first compression ring and the oil control ring to the lower block through at least one drainage opening in the piston.

10. The method of claim 9, wherein step b) comprises the sub-step of spraying the lubricating oil to a dry sump using an oil injector supplied by an oil reservoir.

11. The method of claim 9, wherein step b) comprises the sub-step of splashing the lubricating oil supplied by a wet sump using the crankshaft and a connecting rod connecting the crankshaft to the piston.

12. The method of claim 9, further comprising the step of providing the at least one drainage opening in the control groove and opening at an interior surface of the piston.

13. The method of claim 9, further comprising the step of selecting the predetermined distance such that the predetermined distance is about equal to a distance of travel of the piston from a top position to a bottom position.

14. The method of claim 9, further comprising the step of supplying a second compression ring in a second compression groove of the piston between the first compression groove and the control groove.

15. A piston for a two-stroke engine that includes an intake port and an exhaust port, the piston having:
a cylindrical shape including an upper surface and an outer circumference;
a first compression ring groove around the outer circumference of an upper portion of the piston, wherein no further compression ring groove is formed above the first compression ring groove;
an oil control ring groove around the outer circumference of a lower portion of the piston at a predetermined distance below the first compression ring groove such that the oil control ring groove does not rise above a bottom of the exhaust or the intake port in the two stroke engine when the piston is placed in the two stroke engine; and
at least one drainage opening providing fluid communication between the outer circumference of the piston and an interior surface of the piston.

16. The piston of claim 15, wherein the predetermined distance is selected to be about equal to a distance of travel of the piston from a top position to a bottom position.

17. The piston of claim 15, wherein the at least one drainage opening is located in the oil control ring groove.

18. The piston of claim 15, wherein the at least one drainage opening is a plurality of drainage openings.

19. The piston of claim 15, wherein the piston has a second compression ring groove between the first compression ring groove and the oil control ring groove.

20. The piston of claim 15, wherein the piston has a scraper ring groove located above the oil control ring groove.
